(19) United States
(12) Patent Application Publication
(10) Pub. No.: US 2015/0332333 A1
(43) Pub. Date: Nov. 19, 2015

(54) System and Method for Providing Advertising Slots Before Hyperlink Destination

(71) Applicants: Arfan Chaudhry, Mississauga (CA); Dicky Kurniawan, Semarang (ID)

(72) Inventors: Arfan Chaudhry, Mississauga (CA); Dicky Kurniawan, Semarang (ID)

(21) Appl. No.: 14/690,462

(22) Filed: Apr. 19, 2015

Related U.S. Application Data
(60) Provisional application No. 61/993,039, filed on May 14, 2014.

(51) Int. Cl. G06Q 30/02; G06F 17/30

(52) U.S. Cl. CPC G06Q 30/0267; G06F 17/30882

(57) ABSTRACT

Disclosed is a system and method for providing ads on mobile devices. In one embodiment, the present invention comprises a software application that is adapted to display an ad to a user before directing the user destination of a hyperlink embedded within the application. The ad remains open on a mobile screen until the user taps a skip/close button. When the ad closes, the user is automatically directed to another website or a hyperlink destination. Accordingly, the user must close or skip the ad before he or she is directed to a hyperlink destination. In another preferred embodiment, the ad is cached to increase the speed of ad content viewing for the user. In this regard, the ad is displayed immediately when the user clicks or taps on a hyperlink instead of being called from an ad server after the hyperlink is activated.

### CROSS-REFERENCE TO RELATED APPLICATION

This application claims the benefit of U.S. Provisional Patent Application No. 61/993,039, filed on May 14, 2014, entitled “System and Method for Providing Advertising Slots Before the Hyperlink Destination in Portable Devices,” which is hereby incorporated by reference in its entirety.

### FIELD OF THE INVENTION

The present invention relates to a system and a method of online advertising. More particularly, the present invention is directed to a system and a method for providing online advertisements on portable electronic devices such as a mobile device.

### BACKGROUND OF THE INVENTION

The distribution of advertising via computers is well established. For instance, advertising spaces on websites are sold much like in periodicals, radio, or television. Depending upon an advertising space, advertisers may utilize the space to display various graphics, pictures, short videos, or text relating to a specific product or service. Large graphics, pictures, and texts, however, require a substantial advertising space, which can be expensive or simply not available. In this regard, many advertisers include short hyperlinks that do not occupy much advertising space, but that can direct users to the advertiser's website.

Such method is generally accomplished by displaying so-called “banners” disposed on the margins of a webpage. Though banners vary in size and shape, many banners are relatively small in size and can only provide relatively little information to the users. Accordingly, banners comprise hyperlinks that can direct the users from the website on which the users are currently visiting to an advertiser's website when the banner is activated via a mouse click.

While banners eventually direct the users to an advertised product or the advertiser's website, the banners alone are ineffective marketing tools because they convey very little information to the users and consumers. Additionally, banners and other online advertisements do not have high consumer outreach and visibility when they are placed on low-traffic websites. Therefore, advertisers are confronted with the difficult task of determining which websites are appropriate for their products or services, and which websites have high-traffic. This task is particularly difficult when advertising on mobile websites because handheld electronic devices such as mobile phones comprise small display screens with limited viewable screen area. Accordingly, with respect to ad viewing, it is more difficult for advertisers to reach a broad cross section of the population with handheld electronic devices.

Therefore, there is a need in the prior art for a new and novel type of online advertising slots that enables portable device application developers to display advertisements in an effective manner. The disclosed invention overcomes such problems in online advertising when advertising space is a main constraint.

### SUMMARY OF THE INVENTION

The present invention discloses a system and a method for providing advertising slots or “ad(s)” displayed to a user before being taken to a final destination of a hyperlink when using portable electronic devices. In one embodiment, an ad is displayed when the hyperlink is activated via a tap or a click, then remains open on a mobile screen until the user taps a skip/close button. When the ad closes, the user is automatically directed to another website or the hyperlink destination. Therefore, the present invention requires the user to activate the skip/close button in order to be redirected to the hyperlink destination, wherein the hyperlink destination may comprise an advertiser's website. In another preferred embodiment, the ad is cached on the user's mobile device or computer so as to increase the speed of ad content viewing for the user.

It is therefore an object of the present invention to provide a method for advertising online, which comprises the method of displaying advertisements via hyperlinks on a mobile device before directing users and consumers to an advertiser's website.

Another object of the present invention is to provide a method for providing advertisements to users of Internet services regardless of the particular mobile applications that are viewed by those users.

In the light of the foregoing, these and other objects are accomplished in accordance with the principles of the present invention. Various other objects, advantages and features of the present invention will become readily apparent to those of ordinary skill in the art, and the novel features will be particularly pointed out in the appended claims.

### BRIEF DESCRIPTION OF THE DRAWINGS

The following detailed description, given by way of example and not intended to limit the present invention solely thereto, will best be appreciated in conjunction with the accompanying drawings, wherein like reference numerals denote like elements and parts, in which:

FIG. 1 depicts a schematic diagram illustrating an exemplary method of advertising using a mobile hyperlink ad slot in accordance with the present invention.

FIG. 2 depicts a schematic diagram of an embodiment of the present invention showing the interrelationship of the various components and usage thereof.

FIG. 3 shows a flowchart illustrating the process of advertising server functionality in association with the mobile hyperlink ad slot in accordance with the present invention.

FIG. 4 shows a flowchart illustrating the process of mobile device system functionality in association with the mobile hyperlink ad slot in accordance with the present invention.

FIG. 5 shows a flowchart illustrating a cost per installation method used by advertisers to pay for installations of applications.

FIG. 6 depicts an exemplary schematic diagram of the computer architecture used to operate the ad server in accordance with the present invention.

### DETAILED DESCRIPTION OF THE INVENTION

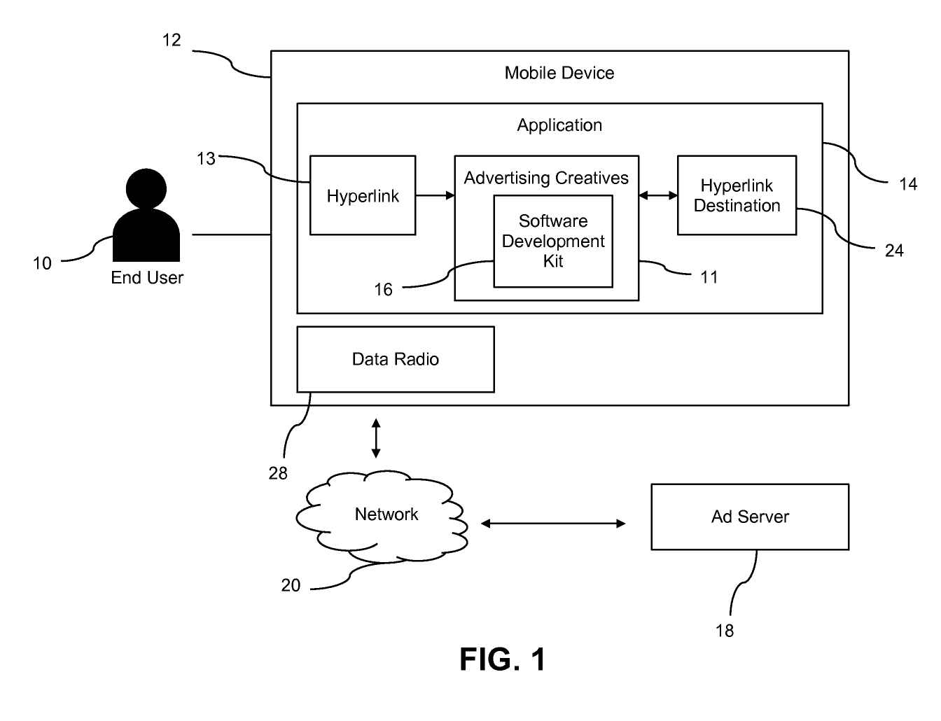

Referring now to FIG. 1, there is shown a schematic diagram illustrating an exemplary method of advertising using a mobile hyperlink ad slot in accordance with the present invention. The present invention comprises a portable electronic device. Without limitation, the electronic device comprises as a tablet computer, a personal digital assistant (PDA), a smart phone, and the like. Therefore it should be understood that system and method of the present invention are taught and disclosed in terms of mobile computing, the same principles are applicable to nearly any device capable of executing machine-readable instruction.

In the illustrated embodiment, the portable electronic device comprises at least one mobile device 12 that is operated by at least one user 10. The mobile device 12 comprises a data radio module 28 for connecting to a network 20 and an application 14 installed thereon, wherein the application 14 is stored in a memory unit of the mobile device 12. The application comprises a software development kit (SDK) 16, which is a mobile device executable software code that may be used to convert a hyperlink into a mobile hyperlink ad slot.

The SDK 16 communicates with third party servers such as an ad server 18 over the network 20. The SDK 16 analyzes hyperlinks 13 within the application 14 to retrieve one or more advertising creatives 11 from the ad server 18. The advertising creative 11 is displayed in the application 14 before directing the user 10 to the destination of the hyperlink 24. The SDK 16 may not be used as long as another code is in place that mimics the same actions as the SDK 16.

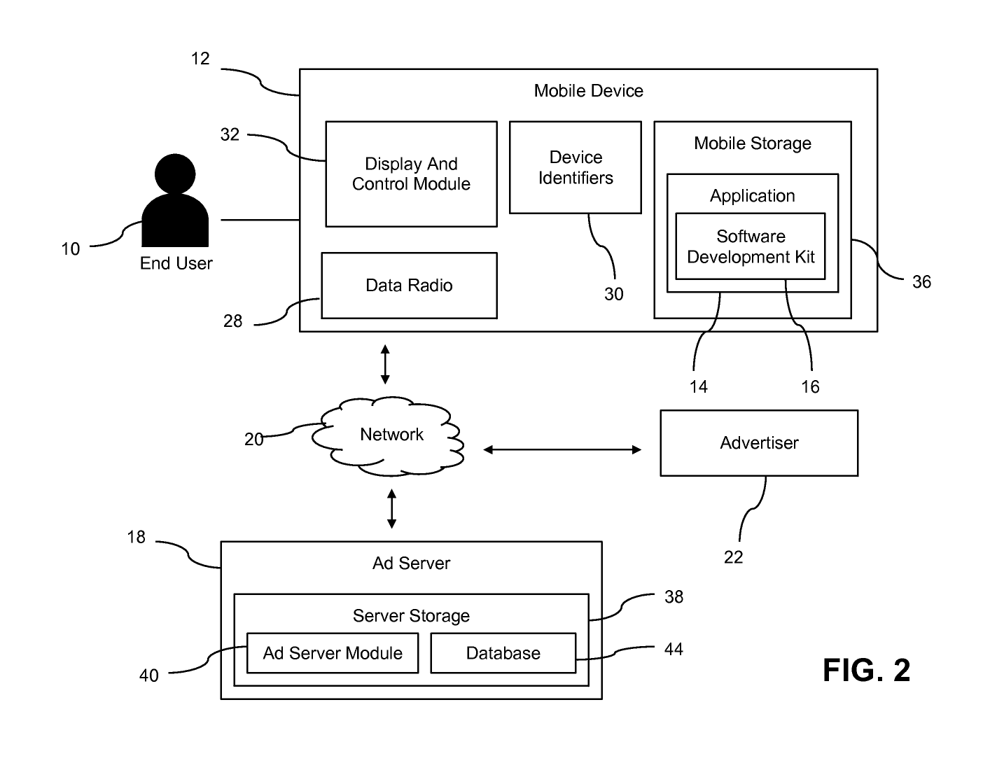

Referring now to FIG. 2, there is shown a schematic diagram of an embodiment of the present invention showing the interrelationship of the various components and the usage thereof. The mobile device 12 comprises device identifiers 30, mobile storage unit 36 for storing the application 14 and SDK 16, a data radio module 28, and a display and control module 32. The foregoing components are integrated together as a single module. The device identifier 30 is associated with the mobile device 12 such that each mobile device comprises a unique device identifier. Without limitation, the device identifier 30 comprises an advertising identifier, MAC address, Internet protocol address, Android device ID, user agent, HTTP cookie, or any other types of identification that can identify a specific mobile device.

The SDK 16 makes ad requests by sending device identifiers 30 to the ad server 18 over the network 20, and receives information therefrom. In this way, the SDK 16 and the ad server 18 comprise bidirectional communication. The ad server 18 comprises a server storage 38, which includes a database 44 and an ad server module 40, wherein the ad server module 40 is a readable instruction module that can perform various functions. In some embodiments, it is contemplated that the server storage 38 further comprises programs, scripts, and advertising creatives, among other types of information and data.

The SDK 16 may use the data radio module 28 of the mobile device 12 to communicate with the ad server 18 via the ad server module 40 over the network 20. It should be understood that the network 20 connecting the ad server 18 with the ad server module 40 and the mobile device 12 may or may not be on the same network. The network 20 may comprise the Internet, wireless communication, mobile communication, local network, metro network, wired network, optical, radio, electrical, telephone line, other network, and the like.

Without limitation, the ad server 18 allows advertisers 22 to register for an account, manage the account, purchase advertising services, upload advertising creatives, and manage campaigns. It is contemplated that information input by the advertisers 22 may be stored in the database 44 on the ad server 18. Advertisers 22 may be a direct advertiser as well as a demand-side platform, ad exchange, ad network, agency, affiliate network, or other parties related to mobile advertising. Advertisers 22 may target their ad campaign on the ad server module 40 by location, specific consumer demographics, network, mobile device make, mobile device model, operating system or platform, and any other information that may be available for the advertiser 22 to target a particular group of users 10 via their mobile devices 12.

Advertisers 22 can purchase advertising services online by uploading advertising creatives to the ad server 18. The advertiser 22 may pay for a campaign based on cost per click/tap, cost per impression, cost per mile, cost per action, cost per install, cost per engagement, or any combination thereof. Any demographic information collected of the users 10 and other information such as the device identifiers 30 are stored on the server storage 38 or the database 44. The stored information may be utilized by a machine learning system to learn users' preferences and behavior in order to improve advertising content and delivery. It is contemplated that the machine learning system or a similar system may be operated via the ad server module 40.

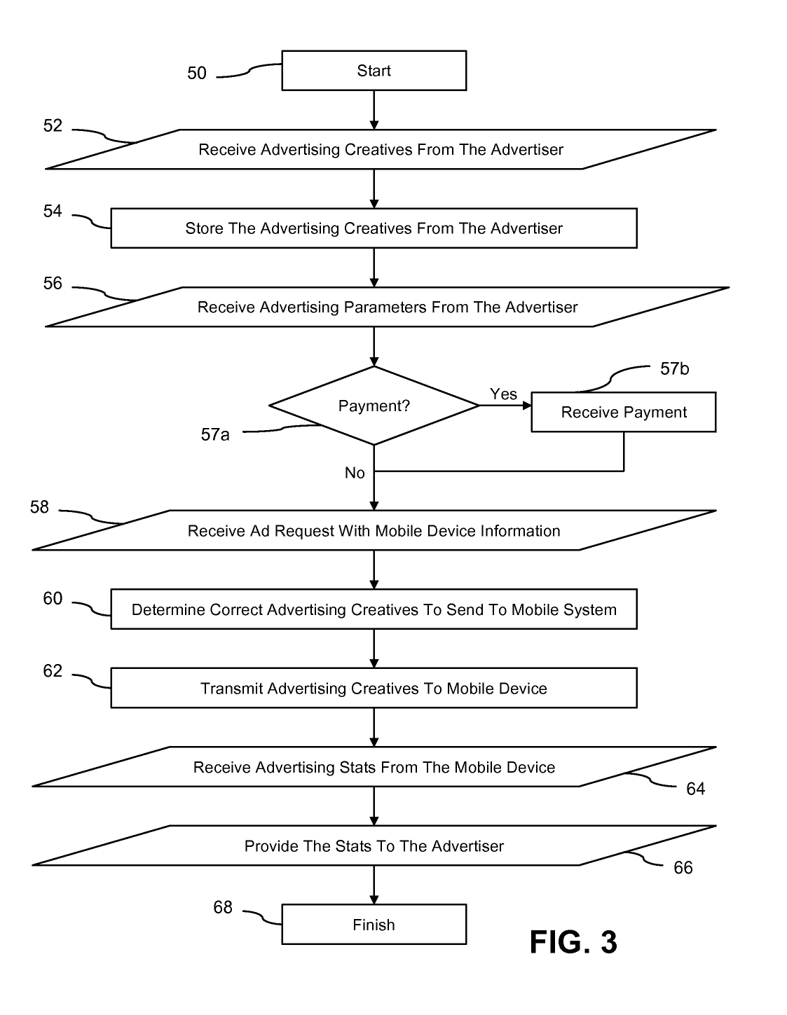

Referring now to FIG. 3, there is shown a flow diagram showing one example of communication between an advertiser and an ad server. It is noted that the operations after the start 50 step are not limited to the ordering shown. In step 52, the ad server receives advertising creatives from the advertiser, and the advertising creatives is stored 54 on the server storage. In step 56, the ad server receives advertising parameters from the advertiser, wherein the advertising parameters are used to reach people of specific demographics. In step 57a, the ad server may require the advertiser to make a payment. If the advertiser is required to make a payment, the ad server may receive a payment 57b from the advertiser. The ad server may retain a percentage of the payment and disburse the remaining payment to the developer of the application in which the advertising creatives is made accessible.

In step 58, the SDK makes an ad request by sending one or more device identifiers to an ad server over a network. This occurs when the user clicks or taps on a hyperlink embedded within the application. Once the ad server receives the ad request, the ad server module then determines the correct advertising creative to send to the SDK 60 to display within the application on the mobile device. Once the correct advertising creative is determined, it is transmitted to the SDK over the network 62 and the advertising creative is shown to the user on his or her mobile device. Thereafter, the SDK transmits stats and data back over the network to the ad server 64. The stats and data may comprise information such as the number of times the advertising creative has been viewed and/or clicked, tapped, or otherwise activated. When the received data is provided to the advertiser 66, and the process is finished 68. In some embodiments, the stats are also provided to the developer of the application that the SDK is integrated in.

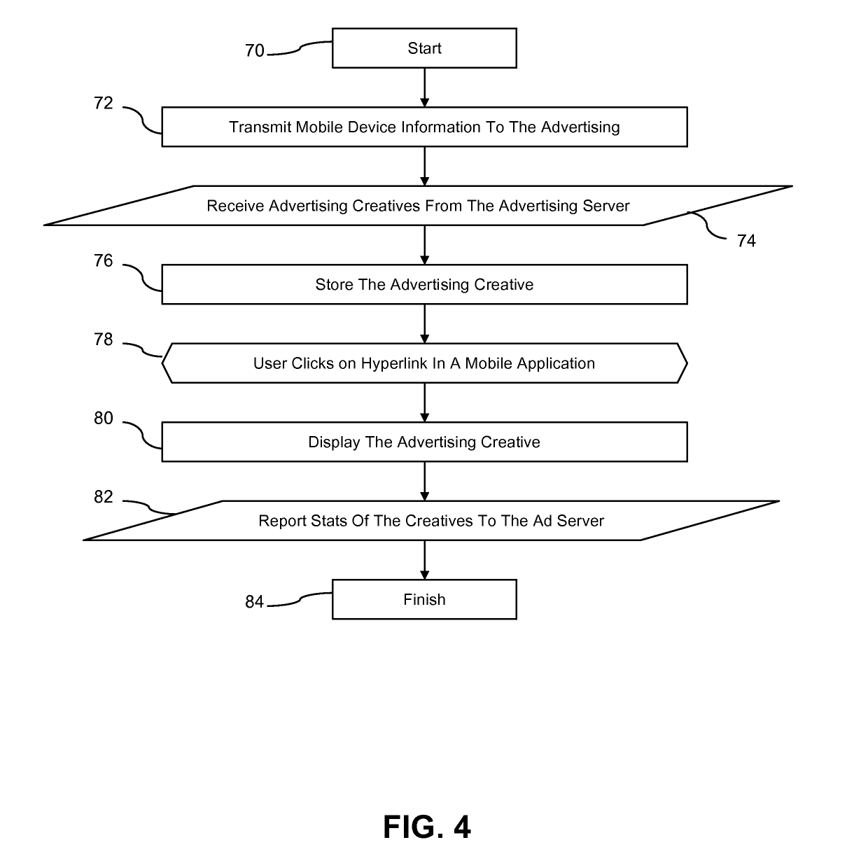

Referring now to FIG. 4, there is shown a flow diagram of the mobile device communicating with the ad server. It is noted that the operations after the start 70 step are not limited to the ordering shown. When the SDK integrated within the operating application is executed, the SDK sends an ad request to the ad server by transmitting one or more device identifiers 72. In step 74, the SDK receives advertising creative from the ad server. In step 76, the received advertising creative may be stored or cached in the mobile storage unit to increase the speed of ad content viewing for the user, depending upon embodiment. In this regard, the ad is displayed immediately when the user clicks or taps on a hyperlink within the application instead of being called from a server after the hyperlink is activated.

In step 78, the SDK is executed again within the application when a hyperlink is activated via click or a tap. In step 80, the advertising creative stored in step 76 is displayed. Thereafter, the user may engage or interact with the ad or skip the ad to be directed to the hyperlink destination. In step 82 the SDK sends stats and back to the ad server when advertising creatives are shown, and the process is finished 84. As discussed above, the stats may also be provided to the developer of the application that the SDK is integrated in.

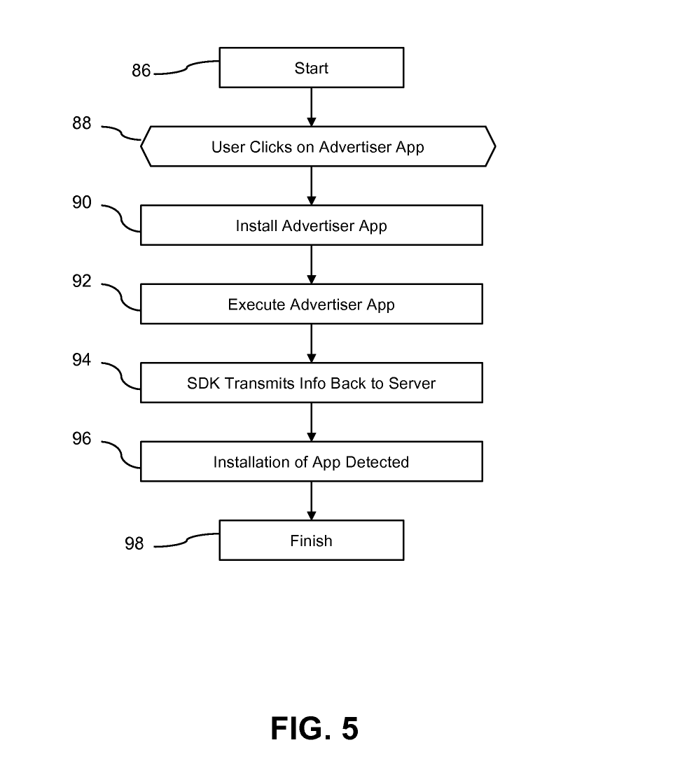

Referring now to FIG. 5, there is shown a flow diagram of a cost per install campaign being executed at step 86 for providing advertising slot before hyperlink destinations within mobile devices. In step 88, user activates an advertising creative by tapping or clicking, wherein the advertising creative is accessible via a first application comprising the SDK. The advertising creative may comprise a link to access a second application such as an advertiser application that is different from the instant application of the present invention. When the advertising creative is activated via a click or a tap, the SDK sends a device identifier to the ad server, which is then stored in the database thereof.

In step 90, the advertiser application is installed on the user's mobile device. In step 92, the installed advertiser application is executed on the user's mobile device. When the advertiser application is executed, the SDK that is integrated within the advertiser application sends the device identifier to the ad server 94. In step 96, the ad server module on the ad server compares and matches the device identifier received in step 88 with the device identifier received in step 94. If the device identifiers match, the advertiser is charged for the application installation. It is contemplated that the advertiser may pay for each application installation via electronic fund transfer from an account associated with the advertiser. Once the advertiser pays for each application installation, the process is finished 98.

In another embodiment, the present invention allows mobile application developers to earn revenue by implementing the SDK within their own mobile applications that will display advertisers' ads. This embodiment requires users to install and execute a developer's application. When the developer's application is executed, the SDK sends a device identifier to the ad server, which is then stored therein. Thereafter, users can utilize the developer's application and interact with advertising creatives therein. Once one or more advertising creatives is activated, the SDK sends the device identifier to the ad server for the second time. The ad server compares the device identifiers to determine if they match. If the device identifiers match, then the developer receives a payment via electronic fund transfer in his or her account, and the process is completed.

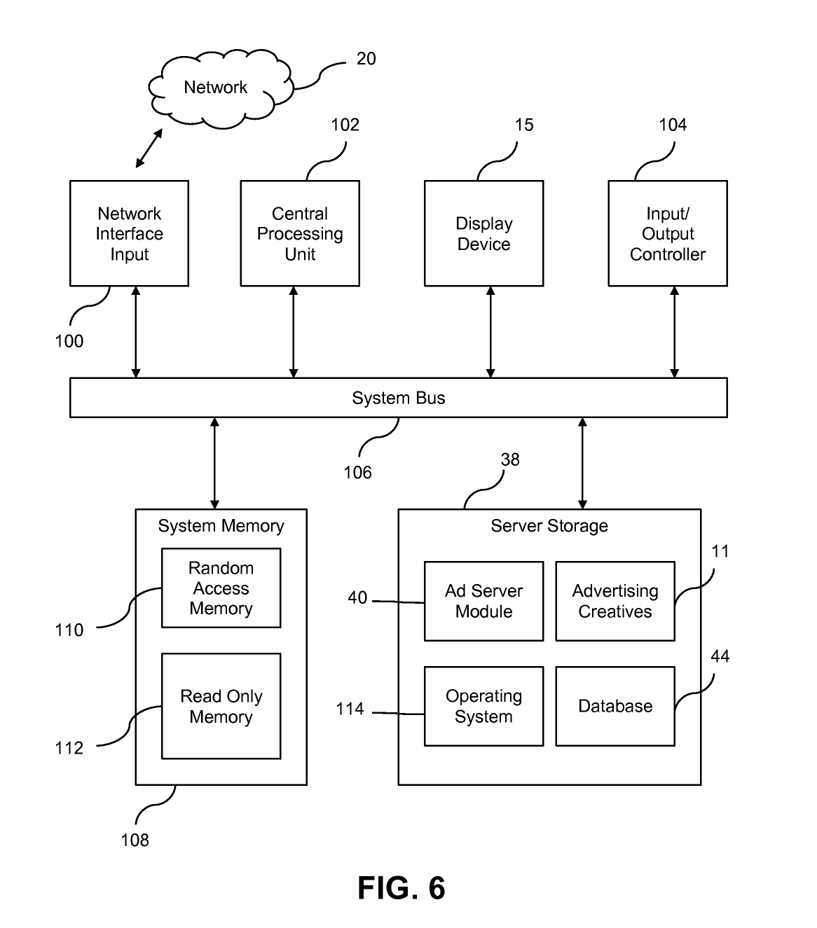

Referring now to FIG. 6, there is shown an exemplary schematic diagram of a computer that is used as an ad server to software component for the present system. The computer comprises a central processing unit (CPU) 102, a network interface input 100 for connecting to a network 20, a display device 15 having a display screen for providing visual displays, input/output controllers 104 for connecting to various peripheral devices and computer accessories, a system memory 108, and a server storage 38. The foregoing components are electrically connected via a system bus 106 so as to allow the components to operate together. Without limitation, the system memory 108 comprises various memory units such as Random Access Memory (RAM) 110, Read Only Memory (ROM) 112, and cache memory. The system memory 108 is separate and distinct from the server storage 38, which comprises the ad server module 40, an operating system 114, advertising creatives 11, and the database 44.

The present method and system of online advertising overcomes the current problems of aggressive advertisement slots provided to end users using mobile applications. Current aggressive advertisement slots discourage end users from utilizing mobile applications, which in turn impacts the long-term revenue stream for mobile applications. In accordance with the present invention, an advertisement module is provided that produces an advertisement slot that is subtle and only displayed to the user before the user is directed to a destination of a hyperlink, wherein the hyperlink is embedded in the application. More specifically, any mobile application developer seeking to create an additional advertisement slot within their mobile application design may integrate the SDK or software module that creates an advertisement slot before directing a user to a hyperlink destination.

In summary, the present invention provides a new advertising slot and method of use, enabling portable device application developers to display advertisements in a convenient manner. Application developers may integrate a SDK or advertisement module that enables a mobile application to create a new advertisement slot or give the developers an opportunity to improve their revenue stream by creating an additional advertisement slot. The new advertisement slot will be displayed before the destination of a hyperlink that has been triggered on by the end user. In use, mobile applications that have hyperlinks may be readily monetized. In this regard, the present invention has a wide application of use. For instance, the present invention may be utilized with a news application or a messaging application where users can exchange messages that include hyperlinks. The present invention may also be used with social network applications that allow users to share hyperlinks. Alternatively, the present invention may be used with applications for vehicles and other electronic devices such as televisions and computers.

It is contemplated for embodiments of the invention to extend to individual elements and concepts described herein, independently of other concepts, ideas or system, as well as for embodiments to include combinations of elements recited anywhere in this application. Although illustrative embodiments of the invention have been described in detail herein with reference to the accompanying drawings, it is to be understood that the invention is not limited to those precise embodiments. As such, many modifications and variations will be apparent to practitioners skilled in this art. Accordingly, it is intended that the scope of the invention be defined by the following claims and their equivalents. Furthermore, it is contemplated that a particular feature described either individually or as part of an embodiment can be combined with other individually described features, or parts of other embodiments, even if the other features and embodiments make no mentioned of the particular feature. This, the absence of describing combinations should not preclude the inventor from claiming rights to such combinations.

In general, the routines executed to implement the embodiments of the invention, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processors in a computer, cause the computer to perform operations necessary to execute elements involving the various aspects of the invention. Moreover, while the invention has been described in the context of fully functioning computers and computer systems, those skilled in the art will appreciate that the various embodiments of the invention are capable of being distributed as a program product in a variety of forms, and that the invention applies equally regardless of the particular type of machine or computer-readable media used to actually effect the distribution. Examples of computer-readable media include but are not limited to recordable type media such as volatile and non-volatile memory devices, USB and other removable media, hard disk drives, optical disks (e.g., Compact Disk Read-Only Memory (CD xROMS), Digital Versatile Disks, (DVDs), etc.), and flash drives, among others.

What is claimed is:

1. An online advertising system, comprising:
a mobile device having a data radio for establishing a wireless connection;
an ad server having a server storage;
said mobile device and said ad server connected via a network;
an application installable on said mobile device, wherein said application provides a hyperlink and a software development kit;
wherein said software development kit communicates with said ad server to retrieve advertising creatives when said hyperlink is activated;
wherein said mobile device displays said advertising creatives before directing a user to a hyperlink destination.

2. The online advertising system of claim 1, wherein said mobile device is associated with a unique device identifier.

3. The online advertising system of claim 2, wherein said software development kit transmits said unique device identifier to said ad server when said hyperlink is activated and said ad server stores said unique device identifier.

4. The online advertising system of claim 1, wherein said software development kit analyzes said hyperlink to retrieve said advertising creatives from said ad server.

5. The online advertising system of claim 1, wherein said server storage comprises an ad server module and a database.

6. The online advertising system of claim 1, wherein said mobile device further comprises a display and control module.

7. The online advertising system of claim 1, wherein said mobile device further comprises a mobile storage;
said mobile storage comprising said application.

8. The online advertising system of claim 1, wherein said server storage comprises said advertising creatives.

9. The online advertising system of claim 1, wherein said application comprises said advertising creatives.

10. A method of advertising online, comprising the steps of:
receiving advertising creatives from an advertiser;
storing said advertising creatives on a server storage;
receiving advertising parameters from said advertiser;
receiving an ad request;
transmitting said advertising creatives to a mobile device;
displaying said advertising creatives on said mobile device;
directing a user to a hyperlink destination.

11. The method of advertising online of claim 10, further comprising the steps of:
transmitting advertising stats from said mobile device to an ad server.

12. The method of advertising online of claim 10, further comprising the steps of:
transmitting advertising stats from said mobile device to said advertiser.

13. The method of advertising online of claim 10, further comprising the steps of:
transmitting advertising stats from said mobile device to a developer of a mobile application stored in said mobile device.

14. The method of advertising online of claim 10, wherein receiving said ad request comprises the steps of:
activating a hyperlink within an application installed in said mobile device;
transmitting a device identifier via a software development kit stored in said mobile device to said ad server;
storing said device identifier in said ad server.

15. The method of advertising online of claim 10, wherein transmitting said advertising creatives to said mobile device comprises the steps of:
analyzing a device identifier received from a software development kit stored in said mobile device;
determining correct advertising creative to send to said mobile device;

16. The method of advertising online of claim 10, further comprising the steps of:
receiving payment from said advertiser;
disbursing said payment to said ad server and a developer of a mobile application having a software development kit integrated therein.

17. The method of advertising online of claim 10, further comprising the steps of:
storing said advertising creatives on said mobile device.

18. The method of generating revenue using advertising campaigns, comprising the steps of:
activating an advertising creative within a first application installed a mobile device;
transmitting a first device identifier via a software development kit to an ad server, wherein said software development kit is integrated within said first application;
storing said device identifier on said ad server.

19. The method of generating revenue using advertising campaigns of claim 18, further comprising the steps of:
installing a second application on said mobile device;
executing said second application on said mobile device;
transmitting a second device identifier via a second software development kit to said ad server, wherein said second software development kit is integrated within said second application;
determining whether said first device identifier and said second device identifier match, if said first device identifier and said second device identifier match, charging an application installation fee.

20. The method of generating revenue using advertising campaigns of claim 18, further comprising the steps of:
activating advertising creatives within said first application;
transmitting a second device identifier via said software development kit to said ad server;
determining whether said first device identifier and said second device identifier match;
if said first device identifier and said second device identifier match, transmitting payment to a developer of said first application.
